(19) United States
(12) Patent Application Publication
(10) Pub. No.: US 2025/0332545 A1
(43) Pub. Date: Oct. 30, 2025

(54) CAPACITIVE DEIONIZATION FILTER AND METHOD FOR MANUFACTURING THE SAME

(71) Applicants: Samsung Electronics Co., Ltd., Suwon-si (KR); HANDOK CLEAN TECH CO., LTD., Yuseong-gu (KR)

(72) Inventors: In Sun KO, Yuseong-gu (KR); Kwang Kyu LEE, Yuseong-gu (KR); Hyeonho LEE, Suwon-si (KR); Gimun GWAK, Suwon-si (KR); Jungha PARK, Suwon-si (KR); Hee Won PARK, Yuseong-gu (KR); Hyunjun CHUNG, Suwon-si (KR); Seul Gi HAN, Yuseong-gu (KR); Keonpyo KOO, Suwon-si (KR); Kisup LEE, Suwon-si (KR)

(21) Appl. No.: 19/250,935

(22) Filed: Jun. 26, 2025

Related U.S. Application Data
(63) Continuation of application No. PCT/KR2025/004289, filed on Apr. 1, 2025.

(30) Foreign Application Priority Data
Apr. 30, 2024 (KR) 10-2024-0057823

(51) Int. Cl. B01D 61/42; B01D 69/12; B01D 71/26; C02F 1/469

(52) U.S. Cl. CPC B01D 61/428; B01D 69/1213; B01D 69/1214; B01D 71/26; C02F 1/4691; B01D 2313/14

(57) ABSTRACT

A capacitive deionization filter includes a cation exchange membrane, a spacer positioned below the cation exchange membrane, an anion exchange membrane positioned below the spacer, and an electrode disposed above the cation exchange membrane or below the anion exchange membrane. An edge of the cation exchange membrane and an edge of the anion exchange membrane may be joined by a plurality of joints formed at a certain interval.

### CROSS-REFERENCE TO RELATED APPLICATIONS

This application is a continuation of International Application No. PCT/KR2025/004289 designating the United States, filed on Apr. 1, 2025, in the Korean Intellectual Property Receiving Office and claiming priority to Korean Patent Application No. 10-2024-0057823, filed on Apr. 30, 2024, the disclosures of each of which are incorporated by reference herein in their entireties.

### BACKGROUND

### Field

The disclosure relates to a capacitive deionization filter and a method for manufacturing the capacitive deionization filter.

### Description of Related Art

A water softener is a device that physically and chemically reduces mineral components contained in hard water, such as Ca2+, Mg2+, Fe3+, etc., to make soft water.

Generally, the ion exchange resin method and the capacitive deionization method are used as the water softening method of a water softener.

The ion exchange resin (IER) method uses ion exchange resins to exchange hard water components in an ionic state with Na ions attached on the ion exchange resins. After removing the hard water components, it is necessary to regenerate the ion exchange resin by injecting NaCl solution. The ion exchange resin method has the advantage of being inexpensive, but has the disadvantage of being able to pollute the environment because the softened water contains a large amount of Na ions.

The capacitive deionization (CDI) method is a method of removing hard water components in an ionic state by applying voltage to the electrodes of a capacitive deionization filter and utilizing the electrical properties of ions. After removing the hard water components, no voltage is applied or a voltage of the opposite polarity is applied to discharge the adsorbed hard water components together with water.

### SUMMARY

According to an example embodiment, a capacitive deionization filter may include: a cation exchange membrane; a spacer positioned below the cation exchange membrane; an anion exchange membrane positioned below the spacer; and an electrode disposed above the cation exchange membrane or below the anion exchange membrane, wherein an edge of the cation exchange membrane and an edge of the anion exchange membrane may be joined by a plurality of joints formed at a specified interval.

According to an example embodiment, the plurality of joints joining the edge of the cation exchange membrane and the edge of the anion exchange membrane may be formed by an ultrasonic fusion machine.

According to an example embodiment, the capacitive deionization filter may further include: a plurality of flow paths formed between the plurality of joints and through which water passes.

According to an example embodiment, the cation exchange membrane and the anion exchange membrane may comprise polyolefin.

According to an example embodiment, the spacer may be porous to allow water to pass therethrough.

According to an example embodiment, a capacitive deionization filter may include: a cation exchange membrane; an electrode positioned below the cation exchange membrane; an anion exchange membrane positioned below the electrode; and a spacer disposed above the cation exchange membrane or below the anion exchange membrane, wherein an edge of the cation exchange membrane and an edge of the anion exchange membrane may be joined to each other.

According to an example embodiment, the edge of the cation exchange membrane and the edge of the anion exchange membrane may be fused by an ultrasonic fusion machine.

According to an example embodiment, a water softener may include: a capacitive deionization filter including one of the features described above; and a housing in which the capacitive deionization filter is accommodated,

According to an example embodiment, a home appliance may include: a case; and a water softener including one of the features described above and disposed inside the case.

According to an example embodiment, a method for manufacturing a capacitive deionization filter may include: preparing a cation exchange membrane, an anion exchange membrane, a spacer, and an electrode; positioning one of the spacer and the electrode between the cation exchange membrane and the anion exchange membrane, and forming the cation exchange membrane and the anion exchange membrane into a pouch; and laminating a remaining one of the spacer and the electrode not included in the pouch onto the pouch.

According to an example embodiment, the forming the cation exchange membrane and the anion exchange membrane into a pouch may include forming a plurality of joints at a specified interval along an edge of the cation exchange membrane and an edge of the anion exchange membrane based on positioning the spacer between the cation exchange membrane and the anion exchange membrane.

According to an example embodiment, the forming the cation exchange membrane and the anion exchange membrane into a pouch may include joining an entire circumference of an edge of the cation exchange membrane and an entire circumference of an edge of the anion exchange membrane based on positioning the electrode between the cation exchange membrane and the anion exchange membrane.

### BRIEF DESCRIPTION OF THE DRAWINGS

These and/or other aspects, features, and advantages of certain embodiments of the present disclosure will be more apparent from the following detailed description, taken in conjunction with the accompanying drawings, in which:

FIG. 1 is a cross-sectional view illustrating a capacitive deionization filter according to various embodiments;

FIG. 2 is a cross-sectional view illustrating a pouch of a capacitive deionization filter according to various embodiments;

FIG. 3 is a diagram illustrating a plan view of a pouch of a capacitive deionization filter according to various embodiments;

FIG. 4 is a diagram illustrating a plan view of a pouch of a capacitive deionization filter according to various embodiments;

FIG. 5 is a cross-sectional view illustrating a capacitive deionization filter according to various embodiments;

FIG. 6 is a cross-sectional view illustrating a capacitive deionization filter according to various embodiments;

FIG. 7 is a cross-sectional view illustrating a pouch of a capacitive deionization filter according to various embodiments;

FIG. 8 is a diagram illustrating a plan view of a pouch of a capacitive deionization filter according to various embodiments;

FIG. 9 is a cross-sectional view illustrating a capacitive deionization filter according to various embodiments;

FIG. 10 is a cross-sectional view illustrating a water softener having a capacitive deionization filter according to various embodiments;

FIG. 11 is a diagram illustrating a home appliance including a water softener according to various embodiments;

FIG. 12 is a flowchart illustrating an example method for manufacturing a capacitive deionization filter according to various embodiments; and

FIG. 13 is an exploded perspective view illustrating a cation exchange membrane, an anion exchange membrane, a spacer, and an electrode for manufacturing a capacitive deionization filter according to various embodiments of the disclosure.

### DETAILED DESCRIPTION

Various example embodiments of the disclosure and terms used herein are not intended to limit the technical features described in the disclosure to specific embodiments, but should be understood to include various modifications, equivalents, or alternatives.

In connection with the description of the drawings, similar reference numbers may be used for similar or related components.

The singular form of a noun corresponding to an item may include one or more of the above item, unless the relevant context clearly indicates otherwise.

In the disclosure, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When it is mentioned that one (e.g., first) component is “coupled” or “connected” to another (e.g., second) component with or without terms “functionally” or “communicatively”, the one component can be connected to the another component directly (e.g., wired), wirelessly, or through a third component.

Terms such as “include” or “have” are intended to designate the presence of features, numbers, steps, operations, components, parts, or combinations thereof described in the various embodiments, but do not preclude the presence or addition of one or more other features, numbers, steps, operations, components, parts, or combination thereof.

When a component is said to be “connected,” “coupled,” “supported,” or “in contact” with another component, this refers not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

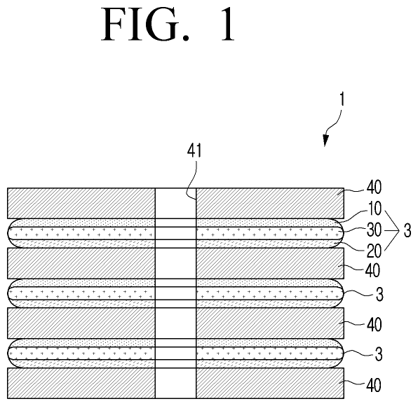

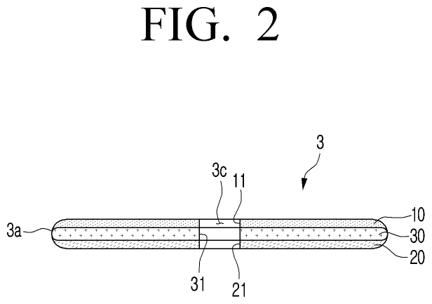

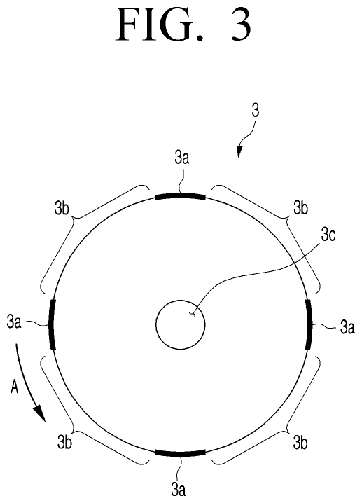

The disclosure relates to a capacitive deionization filter capable of improving assembling efficiency by forming three of four components included in the capacitive deionization filter into a pouch, and a method for manufacturing such a capacitive deionization filter. Hereinafter, a capacitive deionization filter according to various example embodiments of the disclosure will be described in greater detail with reference to FIGS. 1, 2 and 3. FIG. 1 is a cross-sectional view illustrating an example capacitive deionization filter 1 according to various embodiments. FIG. 2 is a cross-sectional view illustrating an example pouch 3 of a capacitive deionization filter 1 according to various embodiments. FIG. 3 is a diagram illustrating a plan view of an example pouch 3 of a capacitive deionization filter 1 according to various embodiments.

Referring to FIG. 1, a capacitive deionization filter 1 according to various embodiments of the disclosure may include a cation exchange membrane 10, a spacer 30, an anion exchange membrane 20, and an electrode 40.

The cation exchange membrane 10 may be configured to adsorb anions contained in water and selectively allow cations to pass therethrough. For example, the cation exchange membrane 10 may include polyolefin.

The cation exchange membrane 10 may be formed in a disk shape with a through hole 11 in the center thereof. For example, the cation exchange membrane 10 may be formed in an approximately donut shape.

The cation exchange membrane 10 may be formed with a thickness of about 15 μm. The diameter of the cation exchange membrane 10 may be appropriately defined according to the processing capacity of the capacitive deionization filter 1.

The spacer 30 may be located below the cation exchange membrane 10. In other words, the spacer 30 may be laminated with the cation exchange membrane 10.

The spacer 30 may allow the cation exchange membrane 10 and the anion exchange membrane 20 to maintain a certain (e.g., specified) gap. The spacer 30 may be configured in a structure through which water may pass. For example, the spacer 30 may be formed in a porous structure through which water may pass. Accordingly, water may move through the spacer 30 between the cation exchange membrane 10 and the anion exchange membrane 20.

The spacer 30 may be formed in a disk shape with a through hole 31 at the center thereof. In other words, the spacer 30 may be formed in a shape corresponding to the cation exchange membrane 10. The through hole 31 of the spacer 30 may be formed in the same manner as the through hole 11 of the cation exchange membrane 10.

The spacer 30 may be formed with a thickness of about 100 μm. The spacer 30 may be formed to have a diameter corresponding to the cation exchange membrane 10. The spacer 30 may include polyethylene terephthalate (PET).

The anion exchange membrane 20 may be configured to adsorb cations contained in water and selectively allow anions to pass therethrough. For example, the anion exchange membrane 20 may include polyolefin.

The anion exchange membrane 20 may be located below the spacer 30. For example, the anion exchange membrane 20 may be laminated with the spacer 30. Therefore, the anion exchange membrane 20 may be spaced apart from the cation exchange membrane 10 by the thickness of the spacer 30.

The anion exchange membrane 20 may be formed in a disk shape with a through hole 21 in the center thereof. For example, the anion exchange membrane 20 may be formed in a shape corresponding to the cation exchange membrane 10. The through hole 21 of the anion exchange membrane 20 may be formed in the same manner as the through hole 11 of the cation exchange membrane 10.

The anion exchange membrane 20 may be formed with a thickness of about 15 μm. The anion exchange membrane 20 may be formed to have a diameter corresponding to the cation exchange membrane 10.

Referring to FIGS. 1 and 2, the cation exchange membrane 10, the spacer 30, and the anion exchange membrane 20 may form a pouch 3. A state in which the spacer 30 is positioned between the cation exchange membrane 10 and the anion exchange membrane 20, and at least portions of the edge of the cation exchange membrane 10 and the edge of the anion exchange membrane 20 are joined to each other may be referred to as the pouch 3. For example, the cation exchange membrane 10 and the anion exchange membrane 20 may form the pouch 3 in which the spacer 30 is accommodated inside.

To this end, the edge of the cation exchange membrane 10 and the edge of the anion exchange membrane 20 may be joined at a certain interval. For example, a plurality of joints 3a may be formed at a certain interval along the edge of the cation exchange membrane 10 and the edge of the anion exchange membrane 20. The cation exchange membrane 10 and the anion exchange membrane 20 may be joined to each other by the plurality of joints 3a.

As illustrated in FIG. 3, the plurality of joints 3a may be formed at regular intervals in the circumferential direction (arrow A direction) of the cation exchange membrane 10 and the anion exchange membrane 20. In the center of the pouch 3, a through hole 3c of the pouch 3 may be formed, in which the through hole 11 of the cation exchange membrane 10, the through hole 31 of the spacer 30, and the through hole 21 of the anion exchange membrane 20 are connected to each other. Water may move through the through hole 3c of the pouch 3.

The length of each of the plurality of joints 3a may for example be a minimum length that prevents and/or reduces the joined cation exchange membrane 10 and anion exchange membrane 20 from being separated.

Water may pass through a plurality of spaces between the plurality of joints 3a in the circumferential direction of the pouch 3. For example, a plurality of flow paths 3b through which water passes may be formed between the plurality of joints 3a. The plurality of flow paths 3b may be formed at regular intervals in the circumferential direction of the cation exchange membrane 10 and the anion exchange membrane 20.

Water may flow into the spacer 30 between the plurality of joints 3a, for example, through the plurality of flow paths 3b, and pass through the spacer 30. The water may be discharged to the outside of the spacer 30 through the plurality of flow paths 3b. The water may not flow into the spacer 30 from the outside through the plurality of joints 3a. The water may not be discharged to the outside from the spacer 30 through the plurality of joints 3a.

To allow water to pass smoothly through the spacer 30, the length of each of the plurality of flow paths 3b in the circumferential direction of the pouch 3 may be formed longer than the length of each of the plurality of joints 3a in the circumferential direction of the pouch 3.

The plurality of joints 3a may be formed by an ultrasonic fusion machine. For example, the plurality of joints 3a may be formed by fusing the edge of the cation exchange membrane 10 and the edge of anion exchange membrane 20 at a certain interval by ultrasonic fusion.

For example, when the ultrasonic fusion machine is operated under the conditions shown in Table 1 below, portions of the edge of the cation exchange membrane 10 and the edge of the anion exchange membrane 20 may be fused to form the pouch 3.

TABLE 1

| condition | unit | range |
|---|---|---|
| pressure | kg/cm² | 0.2~12 |
| frequency | KHz | 5~200 |
| temperature | ° C. | 400~1000 |
| time | second | 0.1~10 |

The pressure, frequency, temperature, and time of the ultrasonic fusion machine may be appropriately defined within the above-described condition range depending on the material, size, and thickness of the cation exchange membrane 10 and the anion exchange membrane 20, the size of the joint 3a, etc. When the pressure, frequency, temperature, and time of the ultrasonic fusion machine are outside the above-described condition range, the cation exchange membrane 10 and the anion exchange membrane 20 may not be joined to form the pouch 3.

FIG. 3 illustrates a case where four joints 3a are formed at the edge of the cation exchange membrane 10 and the edge of the anion exchange membrane 20. Four flow paths 3b through which water may pass are formed between the four joints 3a are illustrated by way of non-limiting example. Water may flow between the outside of the pouch 3 and the through hole 3c of the pouch 3 through the four flow paths 3b.

However, the number of the plurality of joints 3a is not limited thereto. If necessary, the number of plurality of joints 3a may be formed as five or more.

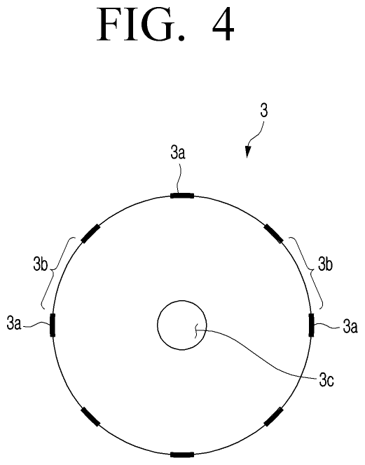

FIG. 4 is a diagram illustrating a plan view of an example pouch 3 of a capacitive deionization filter 1 according to various embodiments.

Referring to FIG. 4, eight joints 3a are formed at the edge of the cation exchange membrane 10 and the edge of the anion exchange membrane 20. Eight flow paths 3b through which water may pass are formed between the eight joints 3a. Water may flow between the outside of the pouch 3 and the through hole 3c of the pouch 3 through the eight flow paths 3b. It will be understood that the number of joints is not limited to eight. When the cation exchange membrane 10, the spacer 30, and the anion exchange membrane 20 are formed into the pouch 3, the cation exchange membrane 10, the spacer 30, and the anion exchange membrane 20 may be integrated to form a single component. Therefore, when assembling the capacitive deionization filter 1, the cation exchange membrane 10, the spacer 30, and the anion exchange membrane 20 may be handled as one component, which makes the assembly convenient.

The electrode 40 may be disposed on top of the cation exchange membrane 10. For example, the electrode 40 may be disposed on top of the pouch 3. The electrode 40 may be laminated with the pouch 3. The pouch 3 may be arranged so the cation exchange membrane 10 faces the electrode 40.

The electrode 40 may be formed in a disk shape with a through hole 41 provided in the center thereof. The through hole 41 of the electrode 40 may be formed in the same manner as the through hole 11 of the cation exchange membrane 10.

The electrode 40 may be formed to have a thickness of about 600 μm. The electrode 40 may be formed to have a diameter corresponding to the cation exchange membrane 10. The electrode 40 may be include carbon. For example, the electrode 40 may be formed by coating activated carbon on the surface of graphite.

When assembling a capacitive deionization filter according to the prior art, four components, e.g., an electrode, a cation exchange membrane, a spacer, and an anion exchange membrane, must be sequentially laminated. However, when assembling the capacitive deionization filter 1 according to various example embodiments of the disclosure, two components, e.g., the pouch 3 in which the cation exchange membrane 10, the spacer 30, and the anion exchange membrane 20 are integrally formed, and the electrode 40 may be laminated, so assembling the capacitive deionization filter 1 may be very easy.

The four components, e.g., the electrode 40, the cation exchange membrane 10, the spacer 30, and the anion exchange membrane 20, may be referred to as one stack, the capacitive deionization filter 1 may be formed by stacking 20 to 70 stacks.

In general, the number of stacks in the capacitive deionization filter may indicate the water softening performance. For example, a dishwasher may require a flow rate of 2.5 LPM (liter/minute). In order to soften this flow rate, a capacitive deionization filter including 20 to 70 stacks may be required.

The electrode, the cation exchange membrane, and the anion exchange membrane may be easily broken because they have low strength. Therefore, the work of laminating the electrode, the cation exchange membrane, and the anion exchange membrane may not be automated using a machine, so they may be laminated manually.

Therefore, the capacitive deionization filter 1 according to various embodiments may reduce the number of components to be laminated compared to the capacitive deionization filter according to the prior art, so that the assembling efficiency may be improved.

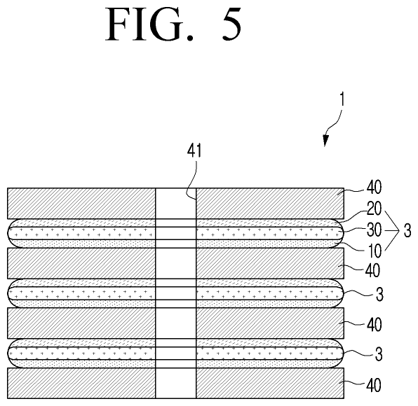

In addition, because the capacitive deionization filter 1 according to various embodiments has a reduced number of components to be laminated, the center alignment of the assembled plurality of stacks may be improved compared to the capacitive deionization filter according to the prior art having a large number of components to be laminated. In the above, the capacitive deionization filter 1 in which the electrode 40 is disposed on top of the cation exchange membrane 10 has been described, but the arrangement of the electrode 40 of the capacitive deionization filter 1 is not limited thereto. As illustrated in FIG. 5, the electrode 40 may be disposed on top of the anion exchange membrane 20. FIG. 5 is a cross-sectional view illustrating an example capacitive deionization filter 1 according to various embodiments.

Referring to FIG. 5, a capacitive deionization filter 1 according to various embodiments of the disclosure may include a cation exchange membrane 10, a spacer 30, an anion exchange membrane 20, and an electrode 40.

The electrode 40 may be disposed on top of the anion exchange membrane 20. In other words, the electrode 40 may be disposed on top of the anion exchange membrane 20 forming the upper surface of the pouch 3. The electrode 40 may be laminated with the pouch 3. Therefore, the anion exchange membrane 20 of the pouch 3 and the electrode 40 may be in contact with each other.

The structure and function of the cation exchange membrane 10, the spacer 30, the anion exchange membrane 20, and the electrode 40 may be the same as or similar to those of the above-described embodiment, so redundant descriptions thereof may not be repeated here.

In the above, the case where the cation exchange membrane 10, the spacer 30, and the anion exchange membrane 20 form the pouch 3 has been described, but the disclosure is not limited thereto. As another example, the cation exchange membrane 10, the electrode 40, and the anion exchange membrane 20 may be formed into the pouch 3.

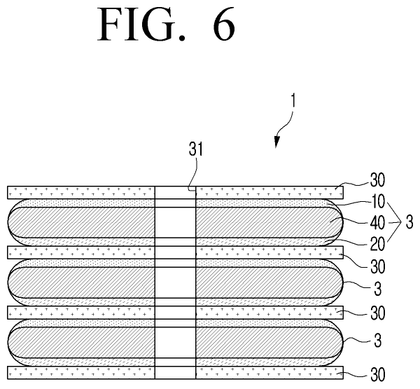

Hereinafter, a capacitive deionization filter 1 according to various embodiments of the disclosure including a pouch 3 formed with a cation exchange membrane 10, an electrode 40, and an anion exchange membrane 20 will be described in greater detail with reference to FIGS. 6, 7, and 8.

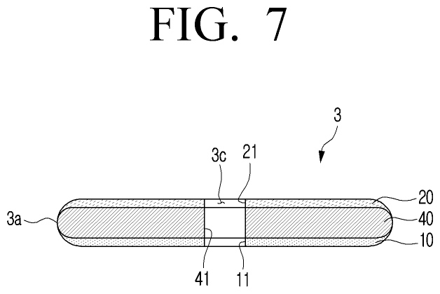

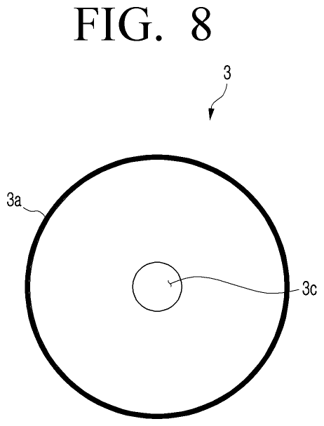

FIG. 6 is a cross-sectional view illustrating an example capacitive deionization filter 1 according to various embodiments. FIG. 7 is a cross-sectional view illustrating an example pouch 3 of a capacitive deionization filter 1 according to various embodiments. FIG. 8 is a diagram illustrating a plan view of an example pouch 3 of a capacitive deionization filter 1 according to various embodiments.

Referring to FIG. 6, a capacitive deionization filter 1 according to various embodiments may include a cation exchange membrane 10, an electrode 40, an anion exchange membrane 20, and a spacer 30.

The cation exchange membrane 10 may be configured to adsorb anions contained in water and selectively allow cations to pass therethrough. For example, the cation exchange membrane 10 may include polyolefin.

The cation exchange membrane 10 may be formed in a disk shape with a through hole 11 in the center thereof. For example, the cation exchange membrane 10 may be formed in an approximately donut shape.

The cation exchange membrane 10 may be formed with a thickness of about 15 μm. The diameter of the cation exchange membrane 10 may be appropriately defined according to the processing capacity of the capacitive deionization filter 1.

The electrode 40 may be located below the cation exchange membrane 10. In other words, the electrode 40 may be laminated with the cation exchange membrane 10.

The electrode 40 may allow the cation exchange membrane 10 and the anion exchange membrane 20 to maintain a certain gap.

The electrode 40 may be formed in a disk shape with a through hole 41 provided in the center thereof. The through hole 41 of the electrode 40 may be formed in the same manner as the through hole 11 of the cation exchange membrane 10.

The electrode 40 may be formed to have a thickness of about 600 μm. The electrode 40 may be formed to have a diameter corresponding to the cation exchange membrane 10. The electrode 40 may include carbon. For example, the electrode 40 may be formed by coating activated carbon on the surface of graphite.

The anion exchange membrane 20 may be configured to adsorb cations contained in water and selectively allow anions to pass therethrough. For example, the anion exchange membrane 20 may be formed of polyolefin.

The anion exchange membrane 20 may be located below the electrode 40. For example, the anion exchange membrane 20 may be laminated with the electrode 40. Therefore, the anion exchange membrane 20 may be spaced apart from the cation exchange membrane 10 by the thickness of the electrode 40.

The anion exchange membrane 20 may be formed in a disk shape with a through hole 21 in the center thereof. For example, the anion exchange membrane 20 may be formed in a shape corresponding to the cation exchange membrane 10. The through hole 21 of the anion exchange membrane 20 may be formed in the same manner as the through hole 11 of the cation exchange membrane 10.

The anion exchange membrane 20 may be formed with a thickness of about 15 μm. The anion exchange membrane 20 may be formed to have a diameter corresponding to the cation exchange membrane 10.

Referring to FIGS. 6 and 7, the cation exchange membrane 10, the electrode 40, and the anion exchange membrane 20 may form a pouch 3. A state in which the electrode 40 is positioned between the cation exchange membrane 10 and the anion exchange membrane 20, and at least portions of the edge of the cation exchange membrane 10 and the edge of the anion exchange membrane 20 are joined to each other is called the pouch 3. In other words, the cation exchange membrane 10 and the anion exchange membrane 20 may form the pouch 3 in which the electrode 40 is accommodated inside thereof.

As illustrated in FIG. 8, the edge of the cation exchange membrane 10 and the edge of the anion exchange membrane 20 may be joined at the entire circumference thereof to form the pouch 3. For example, the entire circumference of the cation exchange membrane 10 and the anion exchange membrane 20 may form a joint 3a.

As another example, the edge of the cation exchange membrane 10 and the edge of the anion exchange membrane 20 may be joined to each other by a plurality of joints 3a formed at regular intervals.

In the center of the pouch 3, a through hole 3c of the pouch 3 may be formed, in which the through hole 11 of the cation exchange membrane 10, the through hole 41 of the electrode 40, and the through hole 21 of the anion exchange membrane 20 are connected to each other. Water may move through the through hole 3c of the pouch 3.

The joint 3a may be formed by an ultrasonic fusion machine. For example, the joint 3a may be formed by fusing the edge of the cation exchange membrane 10 and the edge of anion exchange membrane 20 by ultrasonic fusion.

Joining the cation exchange membrane 10 and the anion exchange membrane 20 using the ultrasonic fusion machine may be the same as or similar to that of the above-described embodiment; therefore, a redundant description thereof may not be repeated here.

When the cation exchange membrane 10, the electrode 40, and the anion exchange membrane 20 are formed into the pouch 3, the cation exchange membrane 10, the electrode 40, and the anion exchange membrane 20 may be integrated to form a single component. Therefore, when assembling the capacitive deionization filter 1, the cation exchange membrane 10, the electrode 40, and the anion exchange membrane 20 may be handled as one component, which makes the assembly convenient.

The spacer 30 may be disposed on top of the cation exchange membrane 10. In other words, the spacer 30 may be disposed on top of the pouch 3. The spacer 30 may be laminated with the pouch 3. The pouch 3 may be arranged so the cation exchange membrane 10 faces the spacer 30.

The spacer 30 may be formed in a disk shape with a through hole 31 provided at the center thereof. The through hole 31 of the spacer 30 may be formed in the same manner as the through hole 11 of the cation exchange membrane 10.

The spacer 30 may allow the two pouches 3 to be stacked to maintain a certain gap. The spacer 30 may be configured with a structure through which water may pass. In other words, the spacer 30 may be formed with a porous structure through which water may pass. Accordingly, water may move through the spacer 30 disposed between the two pouches 3.

The spacer 30 may be formed with a thickness of about 100 μm. The spacer 30 may be formed to have a diameter corresponding to the cation exchange membrane 10. The spacer 30 may include polyethylene terephthalate (PET).

When assembling the capacitive deionization filter according to the prior art, four components, e.g, an electrode, a cation exchange membrane, a spacer, and an anion exchange membrane, must be sequentially laminated. However, when assembling the capacitive deionization filter 1 according to various embodiments of the disclosure, two components, e.g, the pouch 3 in which the cation exchange membrane 10, the electrode 40, and the anion exchange membrane 20 are integrally formed, and the spacer 30 may be laminated, so assembling the capacitive deionization filter 1 may be very easy.

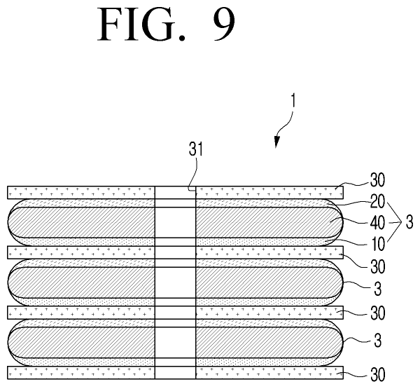

In the above, the capacitive deionization filter 1 having the spacer 30 disposed on top of the cation exchange membrane 10 has been described, but the arrangement of the spacer 30 of the capacitive deionization filter 1 is not limited thereto. As illustrated in FIG. 9, the spacer 30 may be disposed on top of the anion exchange membrane 20.

FIG. 9 is a cross-sectional view illustrating an example capacitive deionization filter 1 according to various embodiments.

Referring to FIG. 9, a capacitive deionization filter 1 according to various example embodiments may include a cation exchange membrane 10, an electrode 40, an anion exchange membrane 20, and a spacer 30.

The spacer 30 may be disposed on top of the anion exchange membrane 20. In other words, the spacer 30 may be disposed on top of the anion exchange membrane 20 forming the upper surface of the pouch 3. The spacer 30 may be laminated with the pouch 3. Therefore, the anion exchange membrane 20 of the pouch 3 and the spacer 30 may be in contact with each other.

The structure and function of the cation exchange membrane 10, the electrode 40, the anion exchange membrane 20, and the spacer 30 may be the same as or similar to those of the above-described embodiment, so redundant descriptions thereof may not be repeated here.

In the above, the cation exchange membrane 10, the anion exchange membrane 20, the spacer 30, and the electrode 40 of the capacitive deionization filter 1 according to various embodiments of the disclosure are illustrated and described in the case where they are formed in a disk shape. However, the shape of the capacitive deionization filter 1 according to various embodiments of the disclosure is not limited thereto.

The cation exchange membrane 10, the anion exchange membrane 20, the spacer 30, and the electrode 40 included in the capacitive deionization filter 1 according to various embodiments of the disclosure may be formed as flat plates of various shapes other than the disk shape. For example, the cation exchange membrane 10, the anion exchange membrane 20, the spacer 30, and the electrode 40 may be formed in a rectangular shape. The capacitive deionization filter 1 according to various embodiments having the above structure may be used in a water softener.

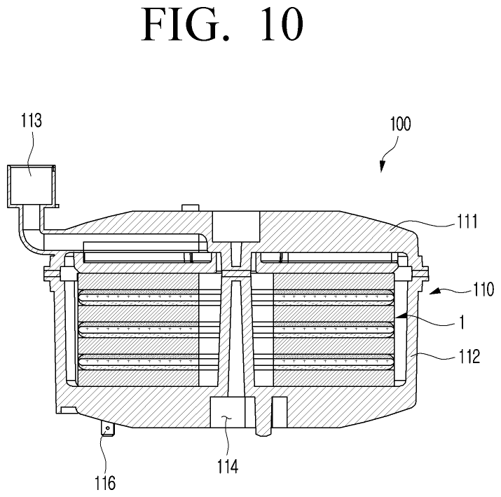

FIG. 10 is a cross-sectional view illustrating an example water softener having a capacitive deionization filter 1 according to various embodiments.

Referring to FIG. 10, a water softener 100 may include a capacitive deionization filter 1 according to various embodiments of the disclosure and a housing 110.

The capacitive deionization filter 1 according to various embodiments has been described above, so a redundant description thereof may not be repeated here.

The housing 110 may be formed to accommodate the capacitive deionization filter 1. The housing 110 may include an internal space in which the capacitive deionization filter 1 is accommodated.

The housing 110 may include an inlet 113 through which water flows in and an outlet 14 through which water flows out. The inlet 113 may be formed on the upper surface of the housing 110, and the outlet 14 may be formed on the lower surface of the housing 110. Water flowing in through the inlet 113 may pass through the capacitive deionization filter 1, and may be discharged through the outlet 114.

The housing 110 may include a terminal 116 configured to apply voltage to the electrode 40 of the capacitive deionization filter 1.

The housing 110 may include an upper housing 111 and a lower housing 112.

The lower housing 112 may be formed in a container shape with an open top. The internal space of the lower housing 112 may be formed to accommodate the capacitive deionization filter 1. For example, when the capacitive deionization filter 1 is formed in a cylindrical shape, the lower housing 112 may be formed in a hollow cylindrical shape with a bottom.

The outlet 114 through which water is discharged may be formed on the bottom of the lower housing 112.

The upper housing 111 may be formed to cover the open top of the lower housing 112. When the capacitive deionization filter 1 is inserted into the lower housing 112 and the upper housing 111 is covered, the capacitive deionization filter 1 may be fixed.

The inlet 113 through which water is introduced may be formed on the upper surface of the upper housing 111.

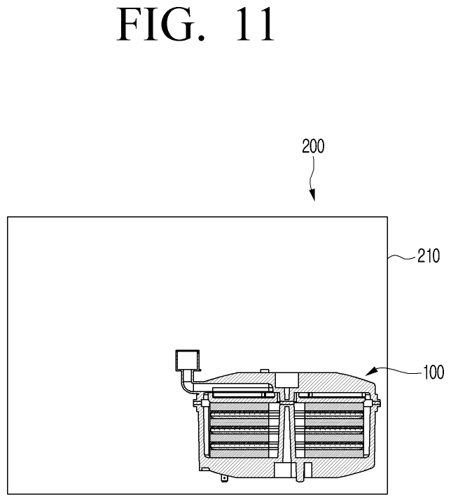

FIG. 11 is a diagram illustrating an example home appliance 200 including a water softener 100 according to various embodiments.

A home appliance 200 may include a device that requires soft water, such as, for example, and without limitation, a dishwasher, washing machine, water purifier, humidifier, and the like, that uses water.

For example, when hard water (e.g., CaCO3 of 120 ppm or more) is used in a dishwasher, the hard water may have a negative effect on detergent dissolution. Therefore, it is desirable to use soft water (e.g., CaCO3 of 60 ppm or less) that is advantageous for detergent dissolution in the dishwasher.

Referring to FIG. 11, the home appliance 200 may include a case 210 and a water softener 100.

The case 210 may form the appearance of the home appliance 200.

The water softener 100 may be disposed inside the case 210. The water softener 100 may include the capacitive deionization filter 1 according to various embodiments of the disclosure.

The inlet 113 and the outlet 114 of the water softener 100 may be connected to the pipes of the home appliance 200. Therefore, the water softener 100 may turn water supplied from the outside to the home appliance 200 into soft water and supply the soft water to a necessary part of the home appliance 200.

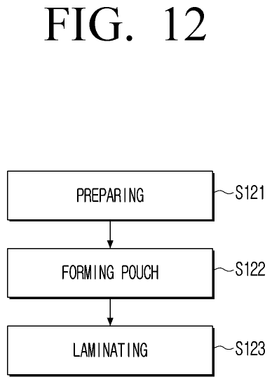

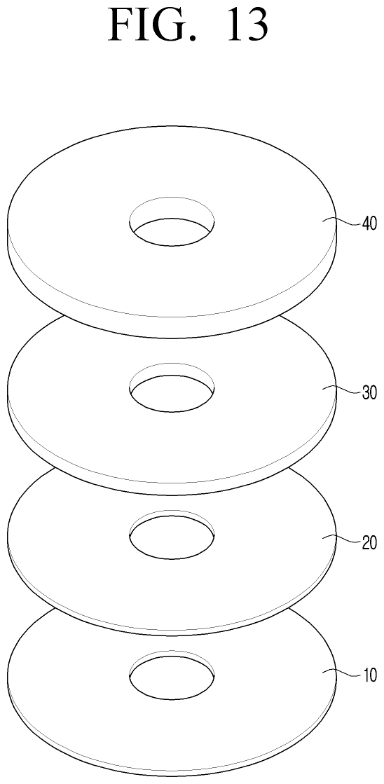

Hereinafter, a method for manufacturing a capacitive deionization filter 1 according to various embodiments of the disclosure will be described in greater detail with reference to FIGS. 12 and 13.

FIG. 12 is a flowchart illustrating an example method for manufacturing a capacitive deionization filter according to various embodiments. FIG. 13 is an exploded perspective view illustrating a cation exchange membrane 10, an anion exchange membrane 20, a spacer 30, and an electrode 40 for manufacturing a capacitive deionization filter 1 according to various embodiments.

Referring to FIG. 12, a method for manufacturing a capacitive deionization filter 1 according to various embodiments may include preparing, forming a pouch, and laminating.

A cation exchange membrane 10, an anion exchange membrane 20, a spacer 30, and an electrode 40 may be prepared (S121).

For example, a material that may be used as the cation exchange membrane 10 may be processed to produce the cation exchange membrane 10 having a certain shape. For example, as illustrated in FIG. 13, a polyolefin used as the cation exchange membrane 10 may be processed to produce the cation exchange membrane 10 having a disk shape and a through hole 11 formed in the center thereof.

A material that may be used as the anion exchange membrane 20 may be processed to produce the anion exchange membrane 20 having a certain shape. For example, as illustrated in FIG. 13, a polyolefin used as the anion exchange membrane 20 may be processed to produce the anion exchange membrane 20 having a disk shape and a through hole 21 formed in the center thereof. The anion exchange membrane 20 may be produced in the same shape and size as the cation exchange membrane 10.

A spacer 30 having a certain shape may be manufactured by processing a material that may be used as the spacer 30. For example, as illustrated in FIG. 13, the spacer 30 having a disk shape and a through hole 31 formed in the center thereof may be manufactured by processing polyethylene terephthalate (PET) used as the spacer 30.

An electrode 40 having a certain shape may be manufactured by processing a material that may be used as the electrode 40. For example, as illustrated in FIG. 13, the electrode 40 having a disk shape and a through hole 41 formed in the center thereof may be manufactured by processing carbon used as the electrode 40.

The cation exchange membrane 10, the anion exchange membrane 20, the spacer 30, and the electrode 40 may be formed to have approximately the same shape and size.

One of the spacer 30 and the electrode 40 may be positioned between the cation exchange membrane 10 and the anion exchange membrane 20, and the cation exchange membrane 10 and the anion exchange membrane 20 may be joined to form a pouch 3 (S122).

For example, the spacer 30 may be positioned between the cation exchange membrane 10 and the anion exchange membrane 20, and the edge of the cation exchange membrane 10 and the edge of the anion exchange membrane 20 may be joined at a certain interval. For example, the edge of the cation exchange membrane 10 and the edge of the anion exchange membrane 20 may be joined at a certain interval using an ultrasonic fusion machine. Then, a plurality of joints 3a may be formed at a certain interval along the edge of the cation exchange membrane 10 and the edge of the anion exchange membrane 20. The spacer 30 may be accommodated between the cation exchange membrane 10 and the anion exchange membrane 20 joined by the plurality of joints 3a.

The spaces between the plurality of joints 3a in the circumferential direction of the pouch 3 may be formed to allow water to pass therethrough. For example, the plurality of portions of the edge of the cation exchange membrane 10 and the edge of the anion exchange membrane 20 where the plurality of joints 3a are not formed may form a plurality of flow paths 3b through which water may move. Water passing through the spacer 30 may move to the outside of the pouch 3 through the plurality of flow paths 3b. Water flowing into the plurality of flow paths 3b from the outside of the pouch 3 may move to the spacer 30.

As another example, the electrode 40 may be positioned between the cation exchange membrane 10 and the anion exchange membrane 20, and at least portions of the edge of the cation exchange membrane 10 and the edge of the anion exchange membrane 20 may be joined. For example, the entire circumference of the edge of the cation exchange membrane 10 and the entire circumference of the edge of the anion exchange membrane 20 may be fused using the ultrasonic fusion machine. The entire circumferences of the edge of the cation exchange membrane 10 and the edge of the anion exchange membrane 20 may be joined to each other. The electrode 40 may be accommodated between the cation exchange membrane 10 and the anion exchange membrane 20 whose entire circumferences are joined.

The pouch 3 may be laminated with the spacer 30 or the electrode 40 (S123). For example, the remaining one of the spacer 30 and the electrode 40 that is not included in the pouch 3 may be laminated on the pouch 3.

For example, when the spacer 30 is accommodated inside the pouch 3, the pouch 3 and the electrode 40 may be laminated. The electrode 40 and the pouch 3 may be laminated so that the electrode 40 comes into contact with the cation exchange membrane 10 of the pouch 3. As another example, the electrode 40 and the pouch 3 may be laminated so that the electrode 40 comes into contact with the anion exchange membrane 20 of the pouch 3.

When the electrode 40 is accommodated inside the pouch 3, the pouch 3 and the spacer 30 may be laminated. The spacer 30 and the pouch 3 may be laminated so that the spacer 30 comes into contact with the cation exchange membrane 10 of the pouch 3. As another example, the spacer 30 and the pouch 3 may be laminated so that the spacer 30 comes into contact with the anion exchange membrane 20 of the pouch 3.

The capacitive deionization filter 1 according to various embodiments of the disclosure having the structure as described above may be improved in assembling efficiency because only two components, e.g, the pouch 3 and the electrode 40 or the pouch 3 and the spacer 30 are laminated.

In addition, in the capacitive deionization filter 1 according to various embodiments of the disclosure, the number of components to be laminated may be reduced. Therefore, the center aliment may be improved compared to the capacitive deionization filter according to the prior art in which the number of components to be laminated is greater than that of the capacitive deionization filter 1 according to various embodiments of the disclosure. In the foregoing, the disclosure has been illustrated and described with reference to various example embodiments. However, it is understood by those skilled in the art that various changes may be made in form and detail without departing from the scope of the disclosure including the appended claims and equivalents thereof. It will also be understood that any of the embodiment(s) described herein may be used in conjunction with any other embodiment(s) described herein.

What is claimed is:

1. A capacitive deionization filter comprising:
a cation exchange membrane;
a spacer positioned below the cation exchange membrane;
an anion exchange membrane positioned below the spacer; and
an electrode disposed above the cation exchange membrane or below the anion exchange membrane,
wherein an edge of the cation exchange membrane and an edge of the anion exchange membrane are joined by a plurality of joints formed at a specified interval.

2. The capacitive deionization filter of claim 1, wherein
the plurality of joints joining the edge of the cation exchange membrane and the edge of the anion exchange membrane are formed by ultrasonic fusion.

3. The capacitive deionization filter of claim 1, further comprising:
a plurality of flow paths formed between the plurality of joints and configured to pass water therethrough.

4. The capacitive deionization filter of claim 1, wherein
the cation exchange membrane and the anion exchange membrane comprise polyolefin.

5. The capacitive deionization filter of claim 1, wherein
the spacer is porous and is configured to allow water to pass therethrough.

6. A capacitive deionization filter comprising:
a cation exchange membrane;
an electrode positioned below the cation exchange membrane;
an anion exchange membrane positioned below the electrode; and
a spacer disposed above the cation exchange membrane or below the anion exchange membrane,
wherein an edge of the cation exchange membrane and an edge of the anion exchange membrane are joined to each other.

7. The capacitive deionization filter of claim 6, wherein
the edge of the cation exchange membrane and the edge of the anion exchange membrane are fused by ultrasonic fusion.

8. The capacitive deionization filter of claim 6, wherein
the cation exchange membrane and the anion exchange membrane comprise polyolefin.

9. The capacitive deionization filter of claim 6, wherein
the spacer is porous and configured to allow water to pass therethrough.

10. A water softener comprising:
a capacitive deionization filter of claim 1; and
a housing in which the capacitive deionization filter is accommodated.

11. A home appliance comprising:
a case; and
the water softener of claim 10 disposed inside the case.

12. A method for manufacturing a capacitive deionization filter, the method comprising:
preparing a cation exchange membrane, an anion exchange membrane, a spacer, and an electrode;
positioning one of the spacer and the electrode between the cation exchange membrane and the anion exchange membrane, and forming the cation exchange membrane and the anion exchange membrane into a pouch; and
laminating a remaining one of the spacer and the electrode not included in the pouch onto the pouch.

13. The method of claim 12, wherein
the forming the cation exchange membrane and the anion exchange membrane into a pouch comprises forming a plurality of joints at a specified interval along an edge of the cation exchange membrane and an edge of the anion exchange membrane based on positioning the spacer between the cation exchange membrane and the anion exchange membrane.

14. The method of claim 13, wherein
spaces between the plurality of joints are configured to allow water to pass therethrough.

15. The method of claim 12, wherein
the forming the cation exchange membrane and the anion exchange membrane into a pouch comprises joining an entire circumference of an edge of the cation exchange membrane and an entire circumference of an edge of the anion exchange membrane based on positioning the electrode between the cation exchange membrane and the anion exchange membrane.
